(19) United States
(12) Patent Application Publication
(10) Pub. No.: US 2017/0224120 A1
(43) Pub. Date: Aug. 10, 2017

(54) BENCH PROVIDING BALLISTIC PROTECTION

(71) Applicant: CLIFTON STEEL COMPANY, MAPLE HEIGHTS, OH (US)

(72) Inventors: MICHAEL S. GEORGIADIS, LYNDHURST, OH (US); JAMES E. SOMOGYI, NORTHFIELD CENTER, OH (US)

(21) Appl. No.: 15/040,769

(22) Filed: Feb. 10, 2016

(51) Int. Cl. A47C 11/00; F16B 12/30; A47C 5/04; F41H 5/24; A47C 4/02

(52) U.S. Cl. CPC A47C 11/00; F41H 5/24; A47C 4/02; A47C 5/04; F16B 12/30

(57) ABSTRACT

A bench including a first support, a second support, a seat, and one or more protective metal plates. The seat extends between the supports. The metal plates extend above the seat or below the seat, or both, and provide at least NIJ Level IIA, preferably Level IV, ballistic protection. The metal plates are attached to the bench, partially or completely, via one or more reversible toolless connections such as a slotted hole and headed stud. The bench can be assembled and disassembled in the field by unskilled labor with few or no tools required.

### FIELD OF THE INVENTION

The invention relates generally to benches, and more particularly to a bench having metal plates and providing at least National Institute of Justice (NIJ) Type IIA ballistic protection.

### DESCRIPTION OF RELATED ART

Benches in public places such as parks, shopping malls, schools, plazas, post offices, court rooms, etc. are well known. Typically these benches are made out of plastic, metal or wood but are not designed to provide protection in case of an attack such as gunfire, grenades, etc. Particularly for military recruiting stations and other military installations and facilities, there is a need for a metal bench which provides ballistic protection and which is easy to assemble and disassemble with unskilled labor with few or no tools required.

### SUMMARY OF THE INVENTION

A bench comprising a first support, a second support, a seat, and a first protective metal plate, the seat extending between the first support and the second support, the first protective metal plate extending above the seat or below the seat or both, the first protective metal plate providing at least NIJ Level IIA ballistic protection. A method of assembling the bench is also provided.

### BRIEF DESCRIPTION OF THE DRAWINGS

FIG. 1 is a front-left-top perspective view of a bench according to the invention;

FIG. 2 is a front elevational view of the bench of FIG. 1;

FIG. 3 is a right side elevational view of the bench of FIG. 1;

FIG. 4 is a left side elevational view of the bench of FIG. 1;

FIG. 5 is a bottom plan view of the bench of FIG. 1;

FIG. 6 is an elevational view showing the inside of the left side panel 4 shown in FIG. 4;

FIG. 6a is an elevational view showing the rear of the left side panel of FIG. 6;

FIG. 6b is an elevational view of the front of the left side panel of FIG. 6;

FIG. 7 is a back elevational view of the bench of FIG. 1;

FIG. 8 is a left side view of the seat of the bench of FIG. 1;

FIG. 9 is a cross sectional view taken along line 9-9 of FIG. 7;

FIGS. 10, 11 and 12 illustrate back plates of the bench of FIG. 1;

FIGS. 13, 14 and 15 illustrate bottom plates of the bench of FIG. 1;

FIG. 16 is a front elevational view of a second embodiment of a bench according to the invention;

FIG. 17a is a flat pattern for a seat brace;

FIG. 17b is a side view of the seat brace after it has been folded or formed;

FIG. 17c is a front view of the seat brace of FIG. 17b; and

FIG. 18 illustrates how the seat brace is attached to the bench below the seat.

### DETAILED DESCRIPTION OF PREFERRED EMBODIMENTS OF THE INVENTION

In the description that follows, when a preferred range, such as 5 to 25 (or 5-25) is given, this means preferably at least 5 and, separately and independently, preferably not more than 25. As used herein and in the claims, NIJ Levels IIA, II, IIIA, III or IV means National Institute of Justice Levels IIA, II, IIA, III or IV as of December 2014.

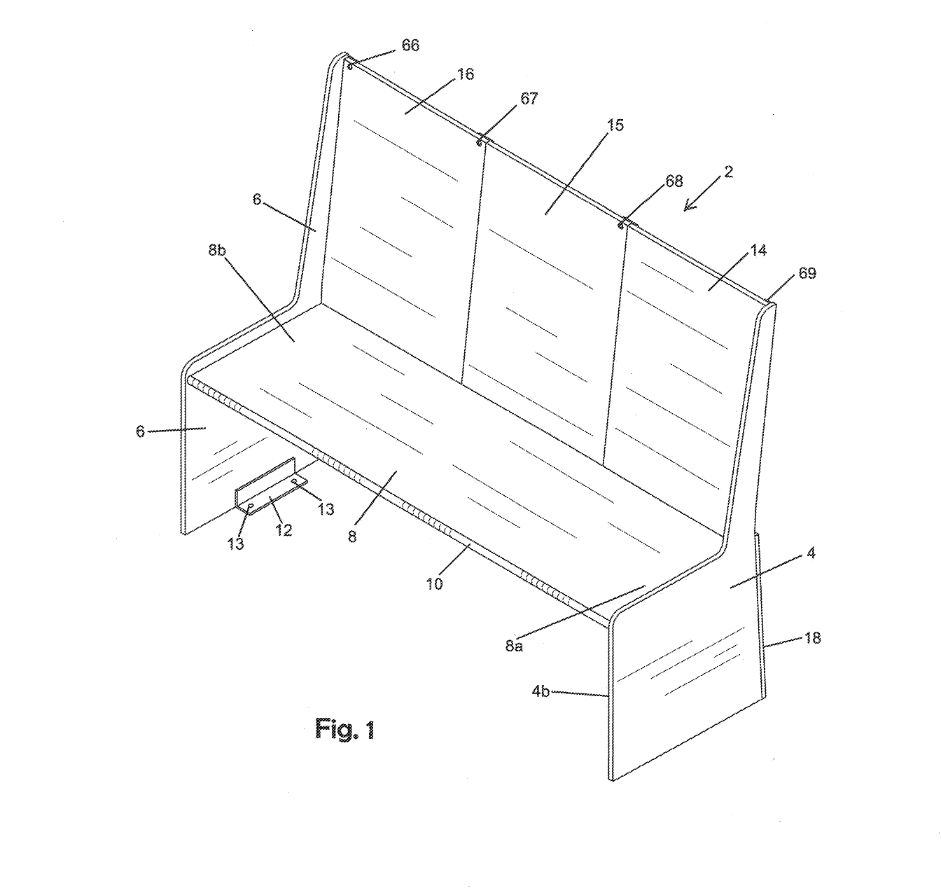

With reference to FIG. 1, there is shown a bench 2 having a seat 8, a first support or left side panel or plate 4 having a front edge 46, a second support or right side panel or plate 6, a first back plate 14, a second back plate 15, and a third back plate 16. The seat 8 has a front 10. As shown in FIG. 9 and the other Figs., each of back plates 14, 15 and 16 extends above the seat 8 and forms a seat back for the seat 8.

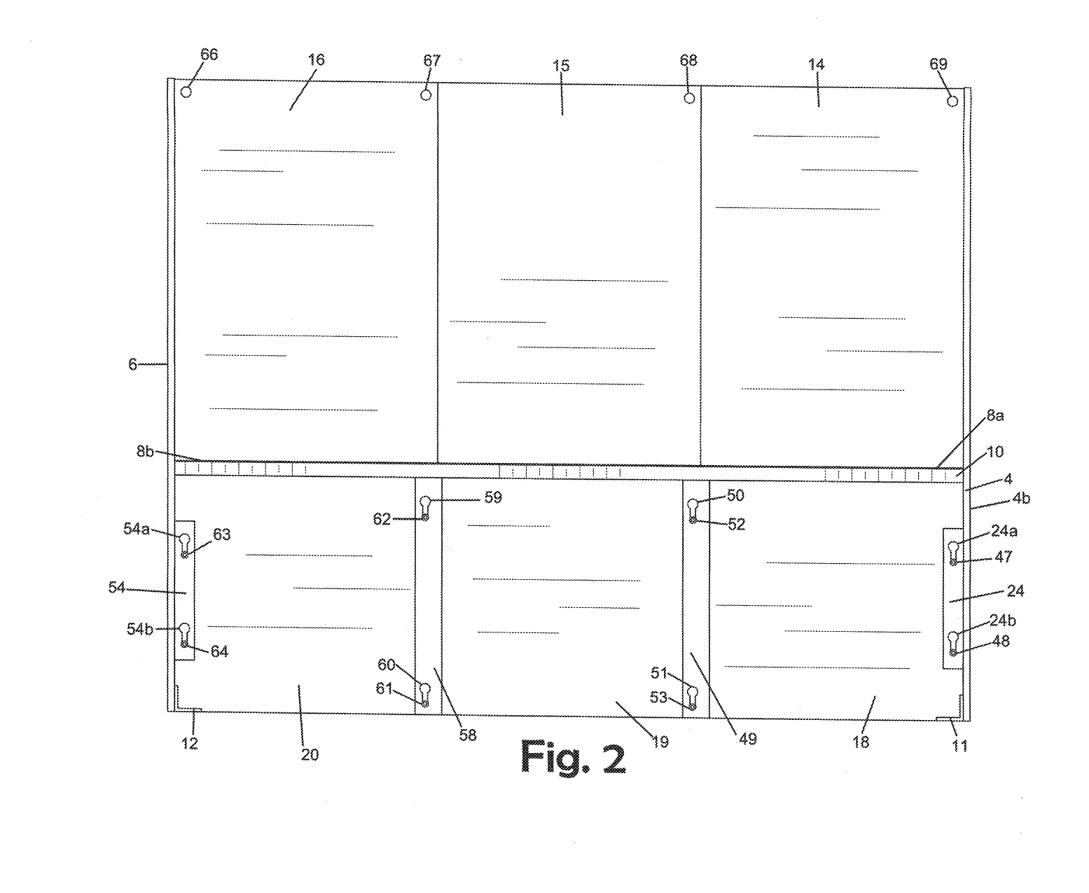

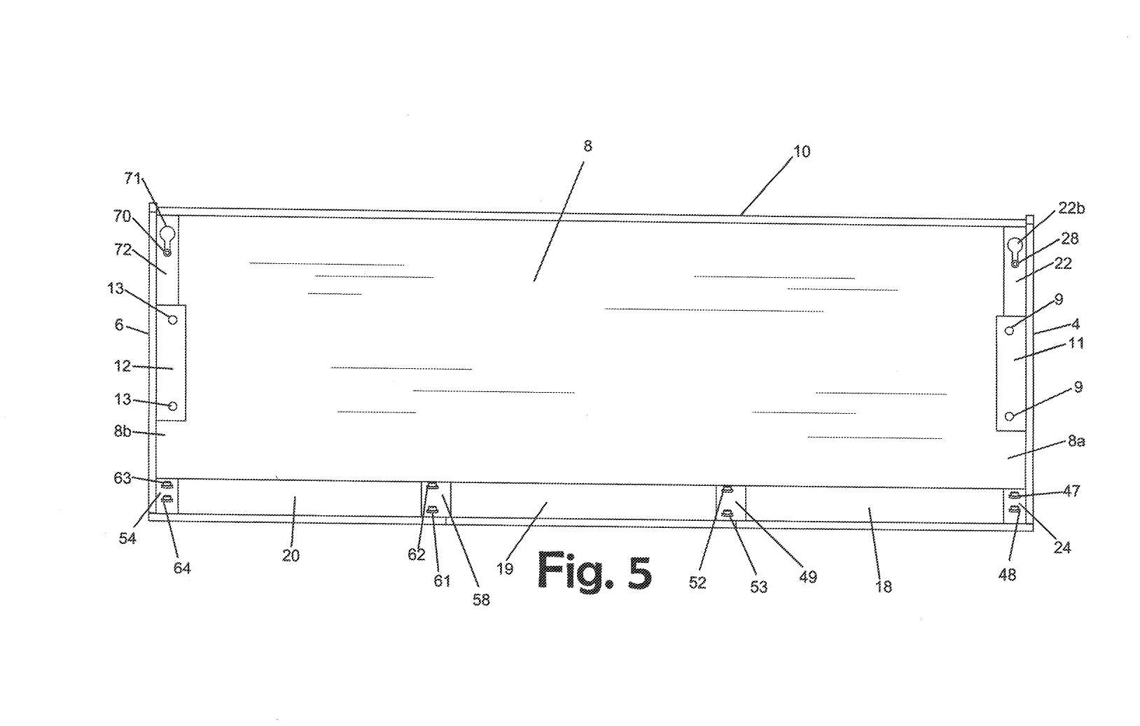

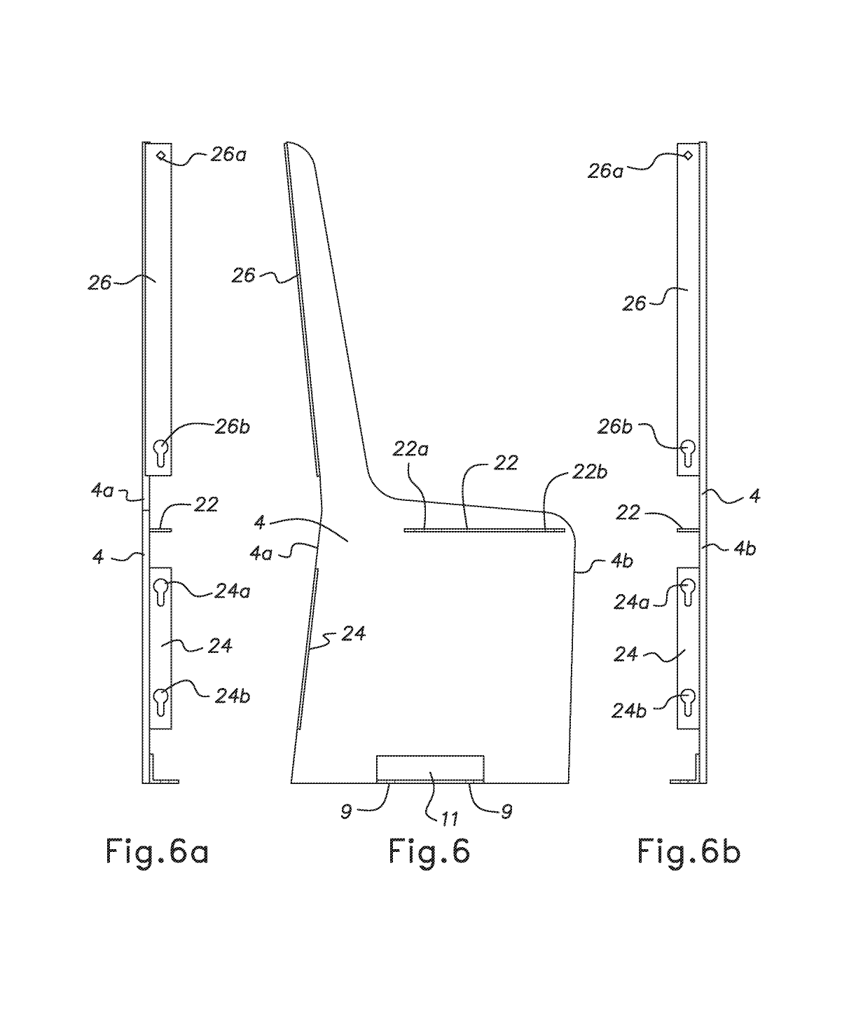

With reference to FIGS. 6, 6a and 6b, a seat bracket or ledge 22 is welded to the inside surface of the left side panel 4; slotted holes or keyhole slots 22a and 22b are provided in seat bracket 22. Bottom panel bracket 24 is welded at the back edge 4a of the left side panel 4; it is provided with slotted holes or keyhole slots 24a and 24b. Back panel bracket 26 is welded to the back edge 4a of the left side panel 4; it is provided with square hole 26a and slotted hole 26b. A left floor bracket 11 (having a pair of holes 9) is attached to the bottom of the left side panel 4. Right side panel 6 is constructed in a similar manner so that it is a mirror image of left side panel 4. In particular, with reference to FIGS. 2, 5 and 7, right side panel 6 has back panel bracket 56 having a square hole 66a at the top and a slotted hole 56b at the bottom. Panel 6 has a bottom panel bracket 54 having slotted holes 54a, 54b; it also has right floor bracket 12 having holes 13, 13.

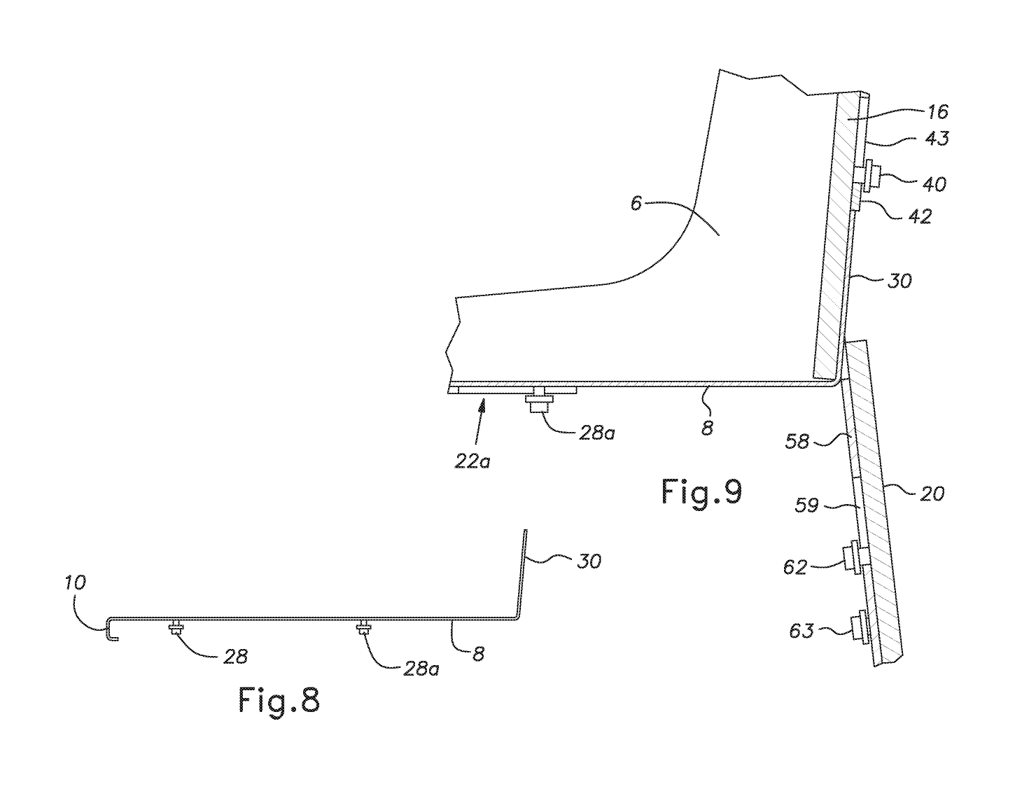

With reference to FIGS. 1, 2, 8 and 5, the seat 8 has a rear flange 30; the front of seat 8 is curved over to form front 10. Near the left end 8a of seat 8 there is a pair of headed studs 28 and 28a which will go into slotted holes 22b, 22a, respectively. Near the right end 8b of seat 8 there is a pair of headed studs (the front one being 70) corresponding to headed studs 28 and 28a; these headed studs go into the slotted holes (the front one is 71) in the seat bracket 72 of right side panel 6 which corresponds to the seat bracket 22 (containing slotted holes 22a, 22b) of left side panel 4.

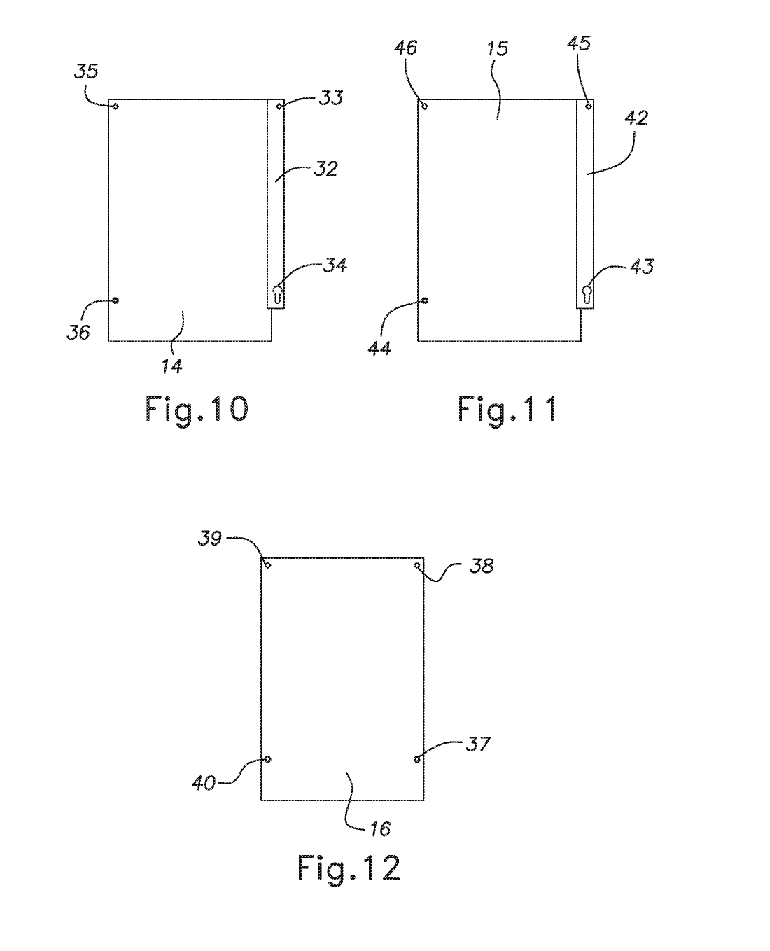

With reference to FIGS. 10-12, seam bracket 32 is welded to first back plate 14; seam bracket 32 is provided with a square hole 33 and a slotted hole 34; first back plate 14 is provided with a square hole 35 and a headed stud 36. Second back plate 15 is the same as first back plate 14 and has seam bracket 42, square hole 45, slotted hole 43, square hole 46 and headed stud 44. Third back plate 16 has a pair of square holes 38, 39 and a pair of headed studs 37, 40.

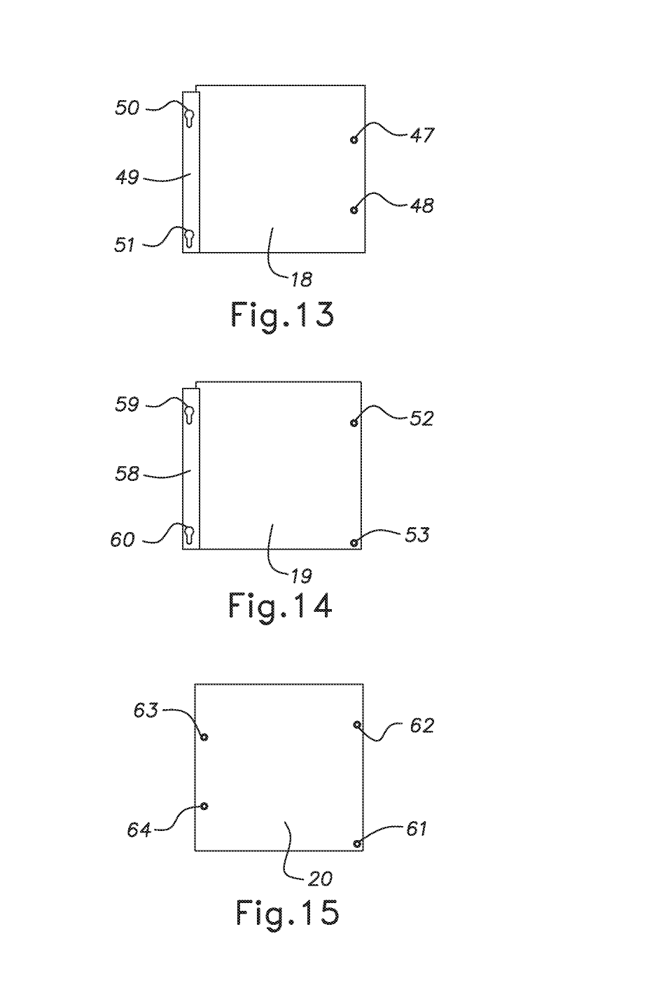

With reference to FIGS. 13-15, seam bracket 49 (having slotted holes 50, 51) is welded to first bottom plate 18. Headed studs 47, 48 are provided on first bottom plate 18. Seam bracket 58 (having slotted holes 59, 60) is welded to second bottom plate 19; headed studs 52, 53 are provided on second bottom plate 19. Third bottom plate 20 is provided with headed studs 61, 62, 63, 64. As shown in FIG. 9 and the other Figs., each of bottom plates 18, 19 and 20 extends below the seat 8 and forms a below seat protector for the bench 2 (and a small portion extends above the seat 8). Each of plates 14, 15, 16, 18, 19 and 20 is a protective metal plate.

The back plates are preferably flat and are preferably 10-30, 15-25, 17-23 or 18-22 or 19-21 or about 20, inches wide and 20-38, 23-35, 26-32 or 28-30 or about 29, inches high. The bottom plates are preferably flat and are preferably 10-30, 15-25, 17-23 or 18-22 or 19-21 or about 20, inches wide and 12-26, 16-24, 18-22 or 19-21 or about 20, inches high. The brackets are preferably 3/16-¼ inch thick hot rolled steel. The seat is preferably 12 gauge hot rolled steel. All of the elements described herein of the bench are preferably metal, preferably steel. The side panels are preferably 30-64, 40-56, 44-52, 46-50, or about 48, inches high and 26-15, 24-19, 23-20 or 22-21, inches wide (at the widest point).

The side panels, back plates and bottom plates are preferably ¼ to ¾, more preferably ⅜ to ⅝, more preferably about ½, inch thick steel, preferably hardened or martensitic steel, such as AR 500 or having a Brinell value of at least 500, providing at least National Institute of Justice (NIJ)(December 2014) Level IIA, II, IIIA, III or IV ballistic protection.

The side panels preferably weigh at least 40, 50, 60, 80 or 100 lbs. and not more than 70, 80, 90, 100, 110, 120, 130, 140, 150, 170 or 190 lbs.

The back and bottom plates preferably weigh at least 20, 22, 26, 30, 35, 40, 45, 50, 55, 60, 65, 70, 80, 90 or 100 lbs. and not more than 30, 35, 40, 45, 50, 55, 60, 65, 70, 80, 90, 100, 110, 120, 130, 140, 150, 160, 170, 180 or 190 lbs.

Preferably, looking at the bench from a front elevational point of view, there is no gap beneath the back plates but above the bottom plates, so that a bullet could not be shot horizontally beneath the back plates but above the bottom plates; less preferably there is such a gap, such as less than 3, 2, 1 or % inches.

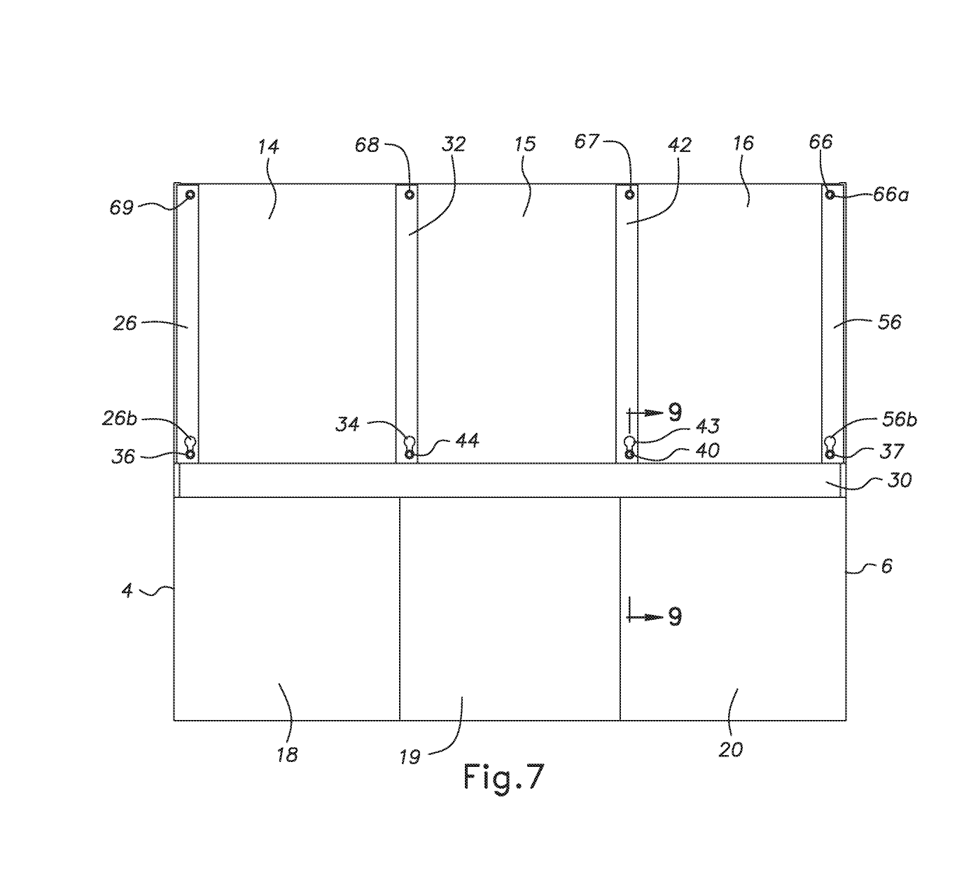

As shown in FIGS. 2 and 7, the bottoms of the left and right side panels define a ground surface between them, and the bottom plates extend to the ground surface. Less preferably the bottom plates extend to within 0.2, 0.5, 0.8, 1, 2 or 3 inches of the ground surface, thus leaving a small gap.

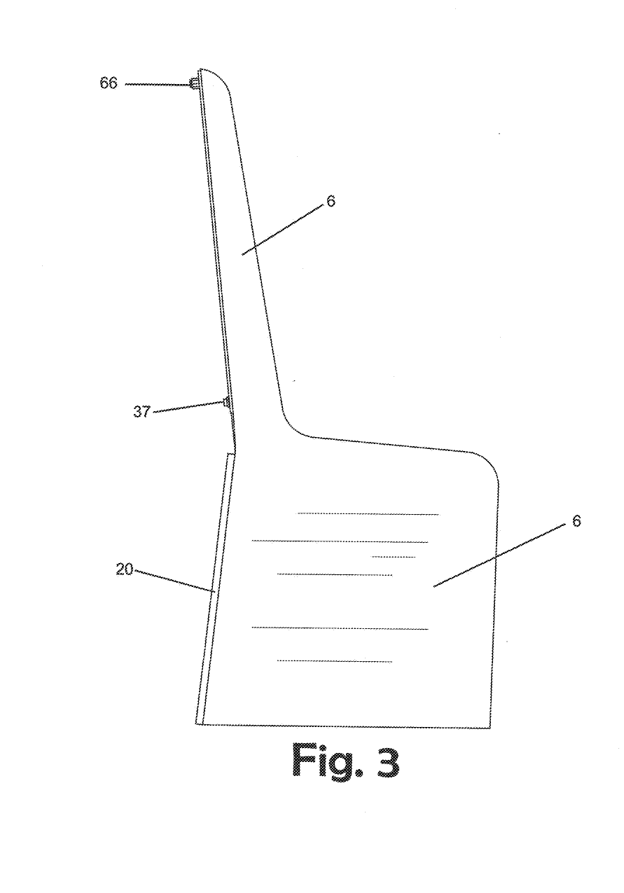

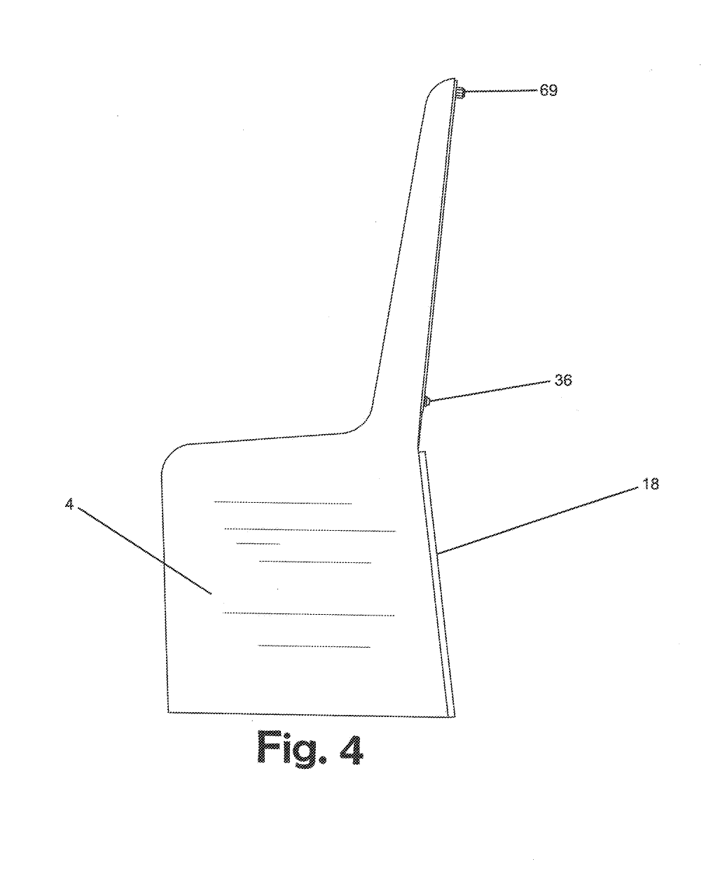

As shown in FIGS. 1, 7 and 9, the bottom plates extend upwardly so that they overlap the bottoms of the back plates; this provides more complete ballistic protection from horizontal projectiles. As shown in FIGS. 3, 4 and 9, the back plates are within about 5 degrees of vertical and the bottom plates are within about 7 degrees of vertical. Less preferably, each of these plates is within 8, 10, 12, 15, 20, 25, 30, 35, 40 or 45 degrees of vertical.

The bench 2 is preferably assembled as follows. First, headed studs 47, 48 of first bottom plate 18 are inserted in slotted holes 24a, 24b of bottom panel bracket 24 of left side panel 4. Headed studs 52, 53 of second bottom plate 19 are inserted in slotted holes 50, 51 of first bottom plate 18. Then (see FIG. 2) headed studs 61, 62, 63, 64 of third bottom plate 20 are inserted in slotted holes 60, 59, 54a and 54b, respectively. The partially assembled bench is now self-standing.

Next, the headed studs 28, 28a near the left end 8a of seat 8 are inserted in slotted holes 22b and 22a, respectively, of seat bracket 22 of left side panel 4. The right side of the bench 2 is symmetrical to the left side of the bench, so that the pair of headed studs (1 is shown at 70) near the right end 8b of seat 8 are inserted in the pair of slotted holes (one of which is shown at 71) in seat bracket 72 of right side panel 6 (see FIG. 5).

Next, (see FIGS. 7 and 10-12) headed stud 36 of first back plate 14 is inserted into slotted hole 26b of back panel bracket 26 of left side panel 4. Then headed stud 44 of second back plate 15 is inserted into slotted hole 34 of first back plate 14. Then, headed studs 37, 40 of third back plate 16 are inserted in slotted holes 56b (of back panel bracket 56) and slotted hole 43, respectively. Finally, carriage bolts 69, 68, 67, 66 are inserted through the square holes 26a, 33, 45, 38, respectively (and other square holes lined up therewith) and tightened with nuts on the carriage bolts; preferably this tightening is by hand only, so that each nut is hand tight; less preferably this tightening is via a wrench.

A toolless connection is a connection whereby a first element is attached to a second element without having to use a tool, ie, by hand. A reversible toolless connection is a connection whereby a first element is attached to, and disattached from, a second element without having to use a tool, le, by hand. In the present Invention, plates or panels attached to the bench via a headed stud and slotted hole are attached via a reversible toolless connection. Less preferably, in the present invention other reversible toolless connections can be used instead of a headed stud and slotted hole, for example, (1) a pin with a hole, along with a cotter pin or hairpin cotter pin (R-clip) through the hole; (2) a pin with a hole, along with a linchpin or pipe linchpin or circle cotter or cotter ring or kickout ring through the hole; (3) a pin with a groove, along with a hairpin dip fixed in the groove; (4) a threaded bolt and wingnut; (5) thumbscrew; (6) a slot (having a lateral cross section with a length greater than its width) through a piece of metal, and a pin extending through the slot and coming out the far side, the pin having a lateral cross section corresponding to the lateral cross section of the slot, the pin having, attached at its tip (which comes out the far side or end of the slot) a bar which can rotate 90° in the plane perpendicular to the longitudinal axis of the pin, so the pin can be reversibly locked in place; (7) a U-shaped groove or narrow tray is formed near where the bottom of a panel will be located and the heavy panel is simply dropped in the tray; (8) a hole or aperture or opening is provided on one element and an extending finger or sliding finger or sliding bolt or clip is fixed to the other element and the finger or bolt is inserted in or slid into the hole or aperture or opening; (9) a sliding latch which can slide down and latch or hold a plate in position; other reversible toolless connections known in the art can be used. A nut tightened by hand only is a reversible toolless connection.

Alternatively, (A) reversible toolless connections (such as slotted hole and headed stud (or others described herein)) or (B) screws or bolts with nuts, can be used in place of the carriage bolts at locations 69, 68, 67, 66. In a preferred embodiment of the invention, all the connections are reversible toolless connections.

The metal bench can then be attached to the ground or floor with fasteners going through holes 13, 13 of right floor bracket 12 and holes 9, 9 of left floor bracket 11.

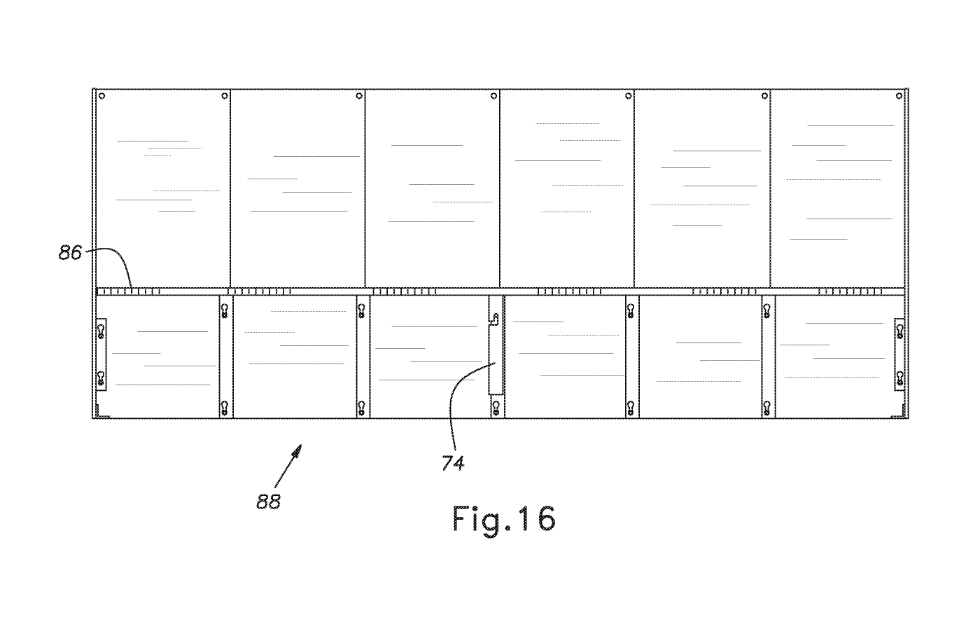

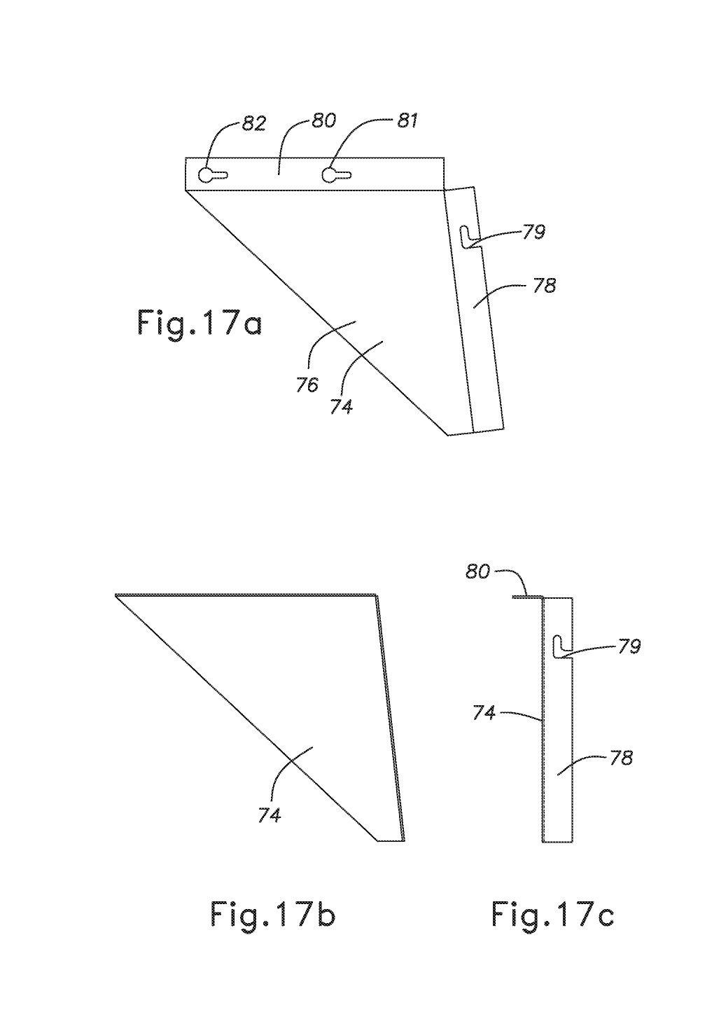

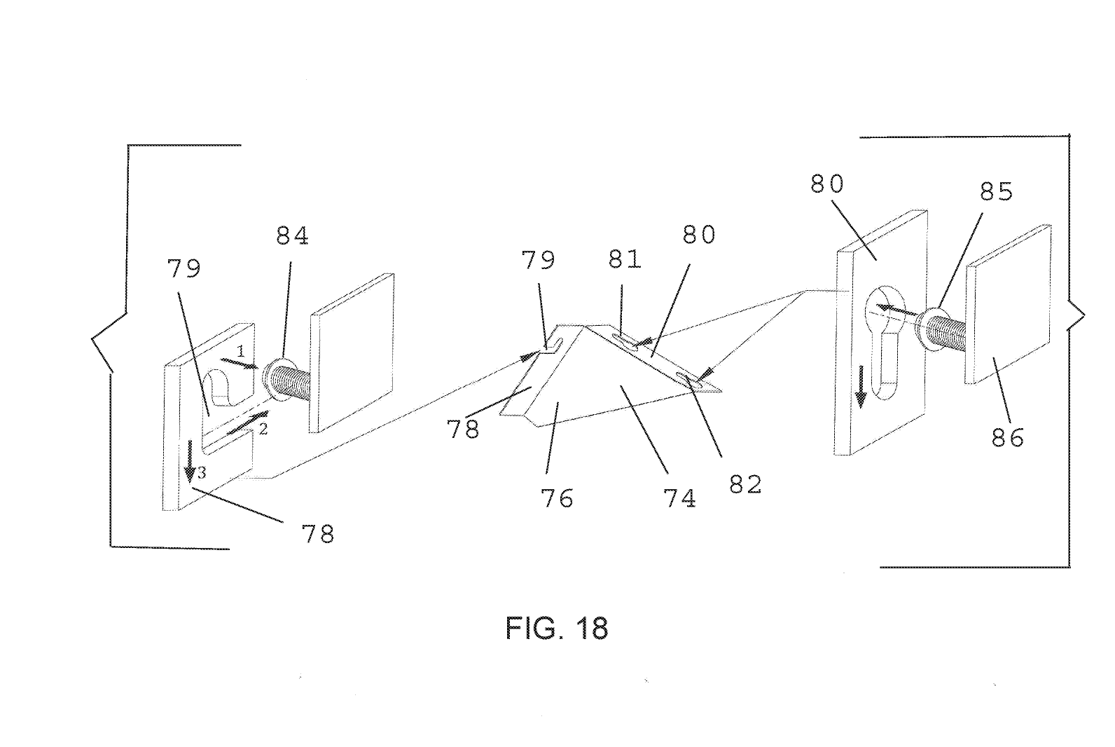

For shorter or longer benches, there can be 1, 2, 4, 5, 6, 7, 8, 9 or 10 back plates and/or bottom plates. FIG. 16 illustrates a longer bench 88 according to the invention, which has a seat brace 74 to help support the long seat 86. FIGS. 17a, 17b and 17c illustrate the seat brace 74, preferably made of 12 gauge cold rolled steel. Seat brace 74 has a main body 76, a side flange 78 having an L slot 79, and a top flange 80 having slotted holes 81, 82. FIG. 18 illustrates how the seat brace 74 is attached to the bench below the seat 86. A pair of headed studs, such as headed stud 85, are fixed to the bottom of seat 86 and engage the slotted holes 81, 82. Headed stud 84 corresponds to headed stud 52 or 62; preferably headed stud 84 is the same as headed stud 52 or 62 except a little bit longer, so that headed stud 84 can engage both (a) a slotted hole corresponding to slotted hole 50 or 59 and (b) L slot 79. Less preferably headed stud 84 is fixed to a seam bracket. The seat brace 74 is attached via these reversible toolless connections.

Alternatively, one or more of the back plates and bottom plates can extend from below the seat to above the seat or vice versa; alternatively a single plate can function as both a back plate and bottom plate.

The bench can be used to provide protection at military recruiting stations, safe houses, storm shelters, parks, schools, shopping malls, plazas, bus stations and shelters, military and law enforcement buildings, bases and facilities, postal facilities, government and educational (eg, college, high school, elementary school) and public buildings and facilities, community and recreational centers, banks, courtrooms, corporate offices, embassies, hotels, stores and gas stations.

One of the benefits of the present invention is that the bench can be assembled and disassembled (for moving to a new location) in the field by unskilled labor without tools, or with simple tools such as screwdriver (including slotted and Phillips head) or wrench (including adjustable, socket, and Allen). The plates are preferably light enough that they can be assembled into, and disassembled from, the bench by hand.

While the invention has been described with reference to the preferred embodiments, it is understood that various changes can be made and equivalents may be substituted for elements thereof without departing from the scope of the invention.

What is claimed is:

1. A bench comprising a first support, a second support, a seat, and a first protective metal plate, the seat extending between the first support and the second support, the first protective metal plate extending above the seat or below the seat or both, the first protective metal plate providing at least NIJ Level IIA ballistic protection.

2. The bench according to claim 1, wherein the first protective metal plate forms a seat back for the seat.

3. The bench according to claim 1, wherein the first protective metal plate forms a below seat protector for the bench.

4. The bench according to claim 1, wherein the first protective metal plate weighs between 20 and 150 lbs.

5. The bench according to claim 1, wherein the first protective metal plate is attached to the bench, partially or completely, via one or more reversible toolless connections.

6. The bench according to claim 1, further comprising a second protective metal plate providing at least NIJ Level IIA ballistic protection, the second protective metal plate extending above the seat to form a seat back or below the seat to form a below seat protector.

7. The bench according to claim 6, further comprising a third protective metal plate providing at least NIJ Level IIA ballistic protection, the third protective metal plate extending above the seat to form a seat back or below the seat to form a below seat protector.

8. The bench according to claim 7, wherein the first, second and third protective metal plates extend above the seat to form a seat back.

9. The bench according to claim 7, wherein the first, second and third protective metal plates extend below the seat to form a below seat protector.

10. The bench according to claim 8, further comprising fourth, fifth and sixth protective metal plates, each providing at least NIJ Level IIA ballistic protection, the fourth, fifth and sixth protective metal plates extending below the seat to form a below seat protector.

11. The bench according to claim 10, wherein each of the fourth, fifth and sixth protective metal plates is attached to the bench solely via reversible toolless connections.

12. The bench according to claim 11, wherein each of the first, second and third protective metal plates is attached to the bench, partially or completely, via reversible toolless connections.

13. The bench according to claim 12, wherein each of the first, second and third protective metal plates is attached to the bench partially via a nut and carriage bolt.

14. The bench according to claim 10, wherein each of the first, second and third protective metal plates is 10 to 30 Inches wide, 20 to 38 inches high, and weighs 20 to 120 lbs.

15. The bench according to claim 10, wherein each of the fourth, fifth and sixth protective metal plates is 10 to 30 inches wide, 12 to 26 inches high, and weighs 20 to 120 lbs.

16. The bench according to claim 10, wherein each of said first, second, third, fourth, fifth and sixth protective metal plates provides at least NIJ Level IV ballistic protection.

17. The bench according to claim 1, wherein the first support, the second support and the seat are metal.

18. The bench according to claim 1, wherein each of said first and second supports comprises a metal plate providing at least NIJ Level IIA ballistic protection.

19. A method of assembling a bench according to claim 1, the method comprising a step of attaching the first protective metal plate to the bench via a plurality of reversible toolless connections.

20. The method according to claim 19, comprising assembling the entire bench, with all of the connections being reversible toolless connections.

21. The method according to claim 19, comprising a step of attaching a protective metal plate to the bench at least partially via a nut and carriage bolt, and tightening the nut by hand only.
